(19) United States
(12) Patent Application Publication
(10) Pub. No.: US 2025/0253743 A1
(43) Pub. Date: Aug. 7, 2025

(54) ELECTRIC MOTOR ASSEMBLY HAVING MOTOR CONTROLLER WITH INVERTER AND CURRENT SENSORS

(71) Applicant: American Axle & Manufacturing, Inc., Detroit, MI (US)

(72) Inventor: Zugang HUANG, Troy, MI (US)

(21) Appl. No.: 19/045,179

(22) Filed: Feb. 4, 2025

Related U.S. Application Data
(60) Provisional application No. 63/550,517, filed on Feb. 6, 2024.

(51) Int. Cl. H02K 11/27; H02K 3/42; H02K 11/33

(52) U.S. Cl. CPC H02K 11/27; H02K 3/42; H02K 11/33; H02K 2211/03

(57) ABSTRACT

A motor assembly that includes a stator, an inverter, a concentrator, and a Hall-effect sensor. The stator has a stator core and a set of field winding that are wound about the stator core. The set of field windings has a phase lead. The inverter has a conductor that is electrically and mechanically coupled to the phase lead. The concentrator is generally C-shaped, disposed about the phase lead, and has a pair of end faces that are spaced apart to define an air gap therebetween. The Hall-effect sensor is received in the air gap between the end faces. A width of the air gap is greater than a diameter of the phase lead. The concentrator is configured to have a relatively high magnetic saturation and to permit sensing of relatively high levels of current with improved accuracy.

### FIELD

The present disclosure relates to an electric motor assembly having a motor controller with an inverter and current sensors.

### BACKGROUND

U.S. Pat. No. 11,303,183 issued Apr. 12, 2022 discloses a motor assembly having a motor assembly and a motor controller. The motor assembly includes a stator core and a plurality of field windings that are wound about the stator core. Each of the field windings has a phase lead. The motor controller includes an inverter and a plurality of current sensors. The inverter includes a plurality of phase bus bars, each of which being electrically and mechanically coupled to a corresponding one of the phase leads and configured to transmit power from the inverter to an associated one of the sets of field windings. Each of the current sensors includes a lamination stack and a sensor. The lamination stack is formed of a plurality of generally C-shaped laminations that are received about a corresponding one of the phase leads. The laminations are formed with a constant width. The sensor is disposed in an air gap between the open ends of the laminations and is configured to sense a magnetic field in the air gap during the operation of the electric motor.

While such configuration is suited for its intended purpose, the configuration of the current sensors can be somewhat difficult to package into a volume that is limited by the outside diameter of the stator core when the lamination stack is sized so that it is not saturated by the magnetic field of the phase lead when the motor assembly is operated with relatively high current. Accordingly, there remains a need in the art for a motor assembly having improved current sensors.

### SUMMARY

This section provides a general summary of the disclosure, and is not a comprehensive disclosure of its full scope or all of its features.

In one form, the present disclosure provides a motor assembly that includes a stator, an inverter, a concentrator, and a Hall-effect sensor. The stator has a stator core and a set of field winding that are wound about the stator core. The set of field windings has a phase lead. The inverter has a conductor that is electrically and mechanically coupled to the phase lead. The concentrator is generally C-shaped, disposed about the phase lead, and has a pair of end faces that are spaced apart to define an air gap therebetween. The Hall-effect sensor is received in the air gap between the end faces. A width of the air gap is greater than a diameter of the phase lead. A width of the concentrator between inner and outer surfaces of the concenrator as taken perpendicular to the outside surface increases between a minimum width dimension and a maximum width dimension, wherein a width of the end faces is equal to the minimum width dimension.

In another form, the present disclosure provides a motor assembly that includes a stator, an inverter, a concentrator, and a Hall-effect sensor. The stator has a stator core and a set of field winding that are wound about the stator core. The set of field windings has a phase lead. The inverter has a conductor that is electrically and mechanically coupled to the phase lead. The concentrator is generally C-shaped, disposed about the phase lead, and has a pair of end faces that are spaced apart to define an air gap therebetween. The Hall-effect sensor is received in the air gap between the end faces. A width of the air gap is greater than a diameter of the phase lead. A ratio of the width of the air gap to a width of the end faces is greater than or equal to 1.5.

In still another form, the present disclosure provides a motor assembly that includes a stator, an inverter, a concentrator, and a Hall-effect sensor. The stator has a stator core and a set of field winding that are wound about the stator core. The set of field windings has a phase lead. The inverter has a conductor that is electrically and mechanically coupled to the phase lead. The concentrator is generally C-shaped, disposed about the phase lead, and has a pair of end faces that are spaced apart to define an air gap therebetween. The Hall-effect sensor is received in the air gap between the end faces. A width of the air gap is greater than a diameter of the phase lead. A ratio of a) a spacing distance (D3) between the phase lead and a plane that intersects ends of the end faces that are closest to the phase lead to b) the width of the air gap is 0.18.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a section view of an exemplary motor assembly having current sensors that are constructed in accordance with the teachings of the present disclosure;

FIG. 2 is a section view of a portion of the motor assembly of FIG. 1, illustrating portions of an electric motor and an inverter and a current sensor of a motor controller in more detail;

FIG. 3 is a perspective view of a portion of the inverter, illustrating an inverter mount in more detail;

FIG. 4 is a perspective view of a portion of the motor assembly of FIG. 1, illustrating a plurality of bus bars, including a plurality of phase bus bars, of the inverter, portions of the field windings, including the phase leads, and portions of the current sensors of the motor controller;

FIG. 5 is a section view of a portion of the motor assembly of FIG. 1 illustrating the integration of a sensor assembly about a phase lead; and

FIG. 6 is an end view of a portion of the motor assembly of FIG. 1, illustrating the integration of the current sensors about the phase leads.

Corresponding reference numerals indicate corresponding parts throughout the several views of the drawings.

### DETAILED DESCRIPTION

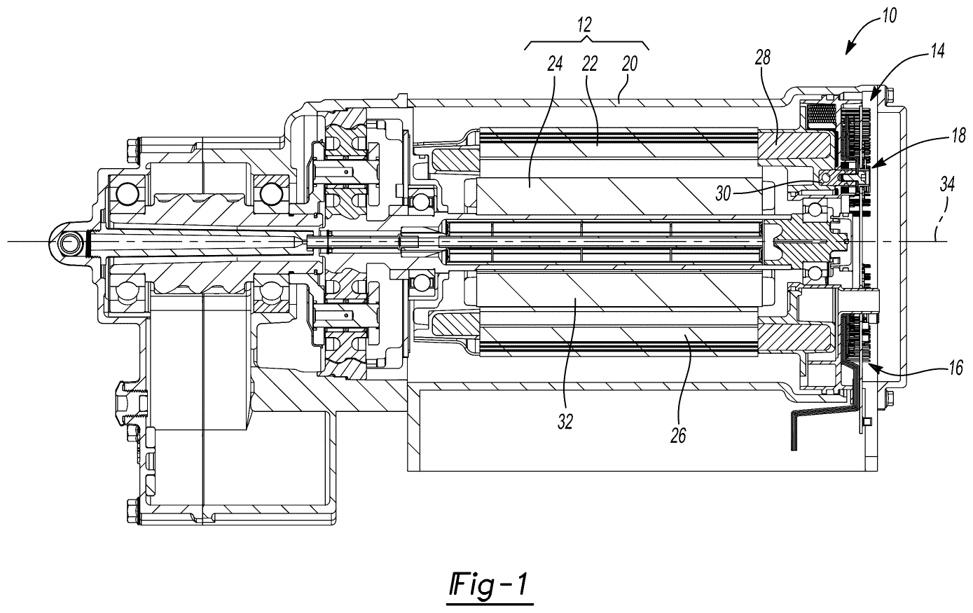

With reference to FIG. 1, a motor assembly 10 includes an electric motor 12 and a motor controller 14 with an inverter 16 and a plurality of current sensors 18 (only one shown). The electric motor 12 includes a motor housing 20, a stator assembly 22 and a rotor assembly 24. The stator assembly 22 is received in the motor housing 20 and has a stator core 26 and a plurality of sets of field windings 28. Each of the sets of field windings 28 includes a phase lead 30. The rotor assembly 24 includes a rotor 32 that is received into the stator core 26 and which is rotatable about a motor axis 34.

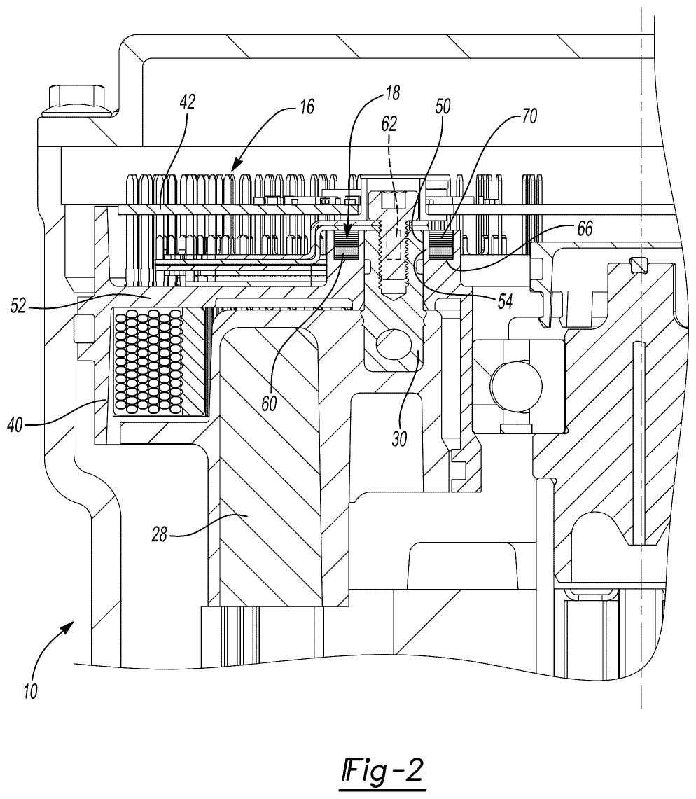

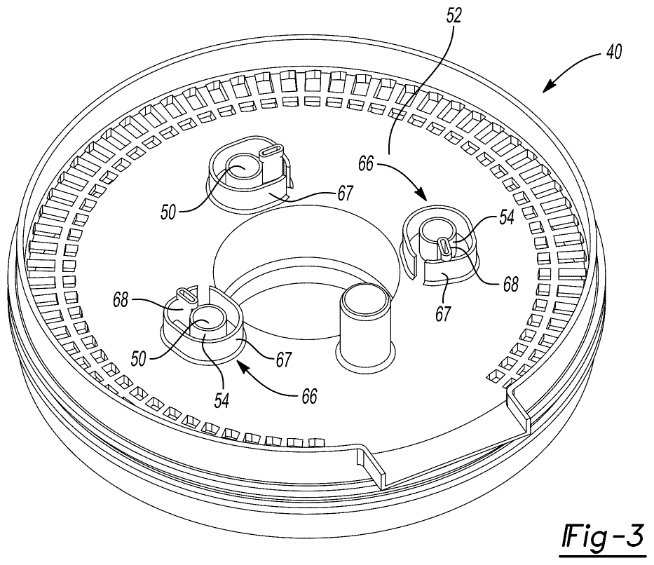

With reference to FIGS. 2 and 3, the inverter 16 includes an inverter mount 40, a circuit board 42 and a plurality of phase bus bars 44. The inverter mount 40 can be coupled to the stator assembly 22 and/or the motor housing 20 and can abut an axial end of the plurality of sets of field windings 28. The inverter mount 40 can be formed of an electrically insulating material and can define a plurality of phase lead apertures 50. In the example provided, the inverter mount 40 has a base 52 and a plurality of tubular members 54. An axial end of each of the tubular members 54 is fixedly coupled to (e.g., integrally and unitarily formed with) the base 52. Each phase lead aperture 50 extends axially through an associated one of the tubular members 54 and through the base 52.

The circuit board 42 includes the circuitry and hardware that is employed to monitor the electric motor 12 and to control the power that is distributed to the electric motor 12 to operate the electric motor 12. The circuit board 42 can be received in the inverter mount 40 and can be spaced apart from the base 52.

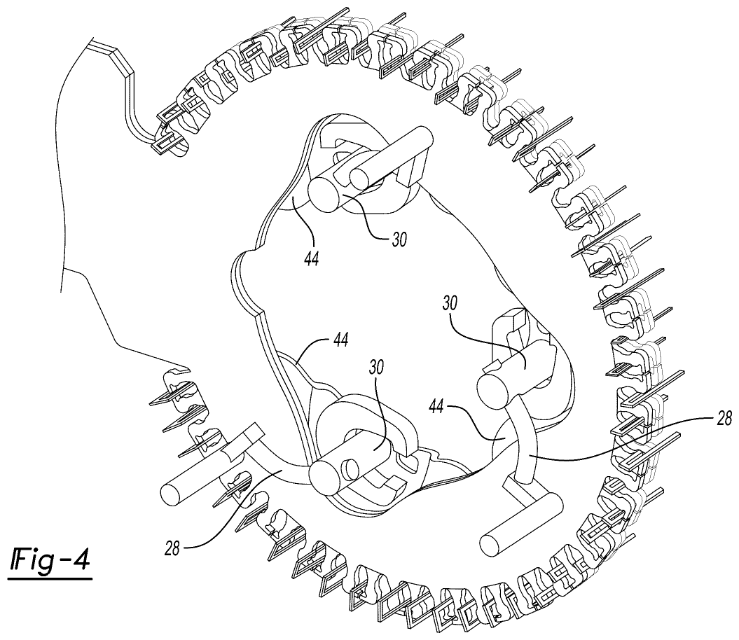

With reference to FIGS. 2 and 4, each of the phase bus bars 44 can be received on the inverter mount 40 between the base 52 and the circuit board 42 and can be mounted to the phase lead 30 of an associated one of the sets of field windings 28. In the example provided, the electric motor 12 is a three-phase electric motor and as such, there are three sets of field windings 28 and three phase bus bars 44 (one of each for each phase).

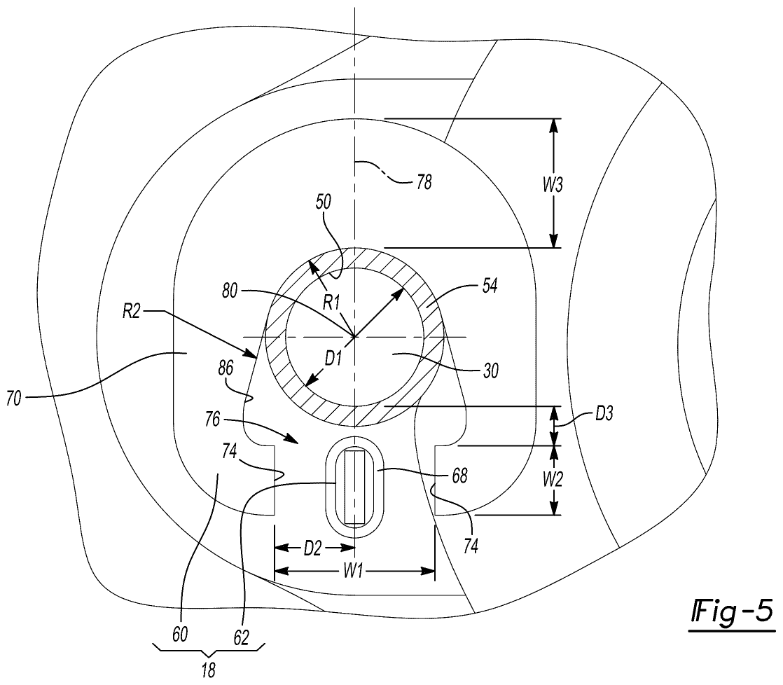

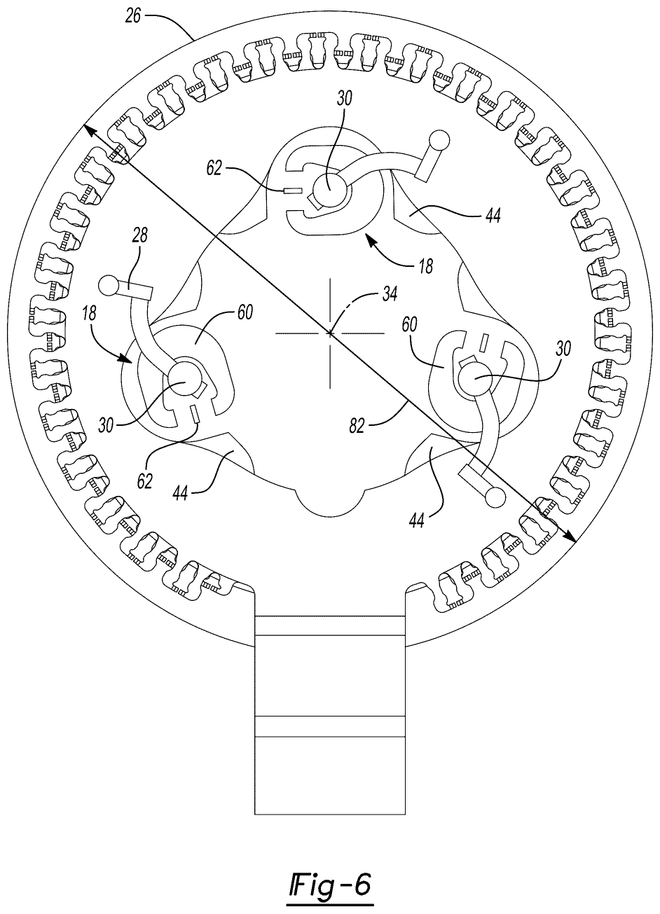

With reference to FIGS. 2, 5 and 6, each of the current sensors 18 includes a concentrator 60 and a sensor 62. The concentrator 60 can be received into a concentrator mount 66 that can be unitarily and integrally formed with the inverter mount 40. The concentrator mount 66 can include a wall member 67 that can extend fully or partly about the concentrator 60 when the concentrator 60 is received in the concentrator mount 66 to thereby maintain the concentrator 60 in a desired orientation about the phase lead aperture 50. The sensor 62 can be a Hall sensor and can be received within a sensor mount 68 that is fixedly coupled to (e.g., unitarily and integrally formed with) the base 52 (FIG. 3) of the inverter mount 40. The sensor mount 68 can have a tubular configuration and can be parallel to but offset from a corresponding one of the tubular members 54 and which can extend from the base 52. The sensor 62 can be electrically coupled to the circuit board 42.

The concentrator 60 can be formed of a ferro-magnetic material (e.g., steel) and received about a corresponding one of the tubular members 54 and an associated one of the phase leads 30. The concentrator 60 can be integrally and unitarily formed, or can be formed of a plurality of lamination members 70. The lamination members 70 are stacked vertically one on another to form the concentrator 60. If employed, the lamination members 70 can each be a thin plate-like structure that can be formed from a suitable material, such as a relatively low carbon steel (e.g., AISI 1010) with a silicon coating. The concentrator 60, and each of the lamination members 70 if the concentrator 60 is formed of a plurality of lamination members 70, can have a generally C-shaped body that defines a pair of end faces 74. The end faces 74 are spaced apart from one another to define an air gap 76 there between that is centered about a sensing axis 78 of the sensor 62 that extends parallel to a longitudinal axis 80 of the phase lead 30.

Given the relatively high transient current supplied to the plurality of sets of field windings 28 during the operation of the motor assembly 10 (FIG. 1) under relatively high loads, the limited packaging space that is available for the packaging of the current sensors 18 within the diameter 82 of the stator core 26 (FIG. 2), which is typically less than about 8.5 inches (216 mm), and is about 7.1 inches (180 mm) in the example provided, which positions the air gap 76 between the end faces 74 relatively close to a respective one of the phase leads 30, and the magnetic fields generated by other components, including the phase bus bars 44 and other ones of the sets of field windings 28, we have determined that the geometry of the concentrator 60 (and the lamination members 70, if used) is critical to the accuracy of the current sensors 18.

In one aspect of the disclosure, the width W1 of the air gap 76 between the end faces 74 can be greater than a diameter D1 of the phase lead 30 that extends longitudinally through the concentrator 60. The air gap 76 is sized and oriented (about the phase lead 30) so that the magnetic fields that emanate from the end faces 74 that act on the opposite sides of the sensor 62 are generally symmetric about the sensor 62 (i.e., symmetric about a plane that extends through the sensing axis 78 of the sensor 62 and the longitudinal axis 80 of the phase lead 30). A distance D2 from the sensing axis 78 to the phase lead 30 can be less than or equal to about three-quarters (i.e., 75%) of the width W1 of the air gap 76 (i.e., the distance between the end faces 74), which can position the ends of the end faces 74 that are closest to the phase lead 30 relatively close to the phase lead 30. In the particular example provided, the distance D2 from the sensing axis 78 to the phase lead 30 is equal to about one-half of the width of the air gap 76 and a ratio of a) the spacing distance D3 from the phase lead 30 to a plane that intersects the ends of the end faces 74 that are closest to the phase lead 30 to b) the width of the air gap 76 is approximately 0.18 (i.e., the ratio of D3 to W1 is approximately 0.18 in the example provided).

In another aspect, the width of the air gap 76 between the end faces 74 can be greater than the width of the end faces 74. A ratio of the width W1 of the air gap 76 to the width W2 of the end faces 74 can be greater than or equal to 1.5, or preferably greater than or equal to 2.0. In the particular example provided the width W1 of the air gap 76 is 11.5 mm, the width W2 of the end face 74 is 5.0 mm and the ratio of the width W1 of the air gap 76 to the width W2 of the end faces 74 is 2.3.

In still another aspect, the width of the concentrator 60 (and lamination members 70 between the outer and inner surfaces of the concentrator 60 (and lamination members 70), as taken perpendicular to its outer surface, need not be constant, but rather can increase from a minimum width dimension (corresponding to W2 in the particular example provided) to a maximum width dimension W3 to provide the lamination members 70 with a relatively higher magnetic saturation point (relative to a configuration that employs a constant width). The minimum width dimension can occur at the end faces 74 (i.e., each end face 74 has a width W2 that is equal to the minimum width dimension), and optionally to other portions of the concentrator 60/lamination member 70. In the example provided, the width of the concentrator 60/lamination members 70 is equal to the minimum width dimension (i.e., W2 in the example provided) at each end face 74 and all about an adjacent 90 degree (rounded) corner of the concentrator 60/lamination member 70 that is adjacent to the end face 74. The maximum width dimension W3 can occur on a side of the concentrator 60/lamination member 70 that is opposite the air gap 76. The maximum width dimension W3 can be greater than or equal to 150% of the minimum width dimension, but in the particular example provided, the maximum width dimension W3, which is 9.25 mm, is 185% greater than the minimum width dimension (corresponding to W2), which is 5 mm. The inside surface 86 of the concentrator 60/lamination member 70 is sized to fit about a corresponding one of the tubular members 54 and to transition between the maximum width dimension W3 and the minimum width dimension in a relatively smooth manner that is preferably relatively easy to manufacture, does not provide stress risers and does not have an adverse effect on the magnetic field in the air gap 76 during operation of the electric motor 12. In the example provided, a portion of the inside surface 86 is defined by a first radius R1 that is somewhat larger than the radius of the tubular member 54 that is received through the concentrator 60/lamination member 70, and a second radius R2, which is tangent to the first radius R1, and which defines the portion of the inside surface 86 that transitions to the (rounded) corner of the concentrator 60/lamination member 70 that is defined by the minimum width dimension.

We have found in our simulations that the current sensors 18 have improved accuracy (generally within 1% of the actual current flowing through the phase lead 30) when configured in the manner described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A motor assembly comprising:
a stator having a stator core and a set of field windings that are wound about the stator core, the set of field windings having a phase lead;
an inverter having a conductor electrically and mechanically coupled to the phase lead;
a concentrator disposed about the phase lead, the concentrator being generally C-shaped and having a pair of end faces that are spaced apart to define an air gap therebetween; and
a Hall-effect sensor received in the air gap between the end faces;
wherein a width of the air gap is greater than a diameter of the phase lead; and
wherein a width of the concentrator between inner and outer surfaces of the concenrator as taken perpendicular to the outside surface increases between a minimum width dimension and a maximum width dimension, wherein a width of the end faces is equal to the minimum width dimension.

2. The motor assembly of claim 1, wherein the maximum width dimension occurs on a portion of the concentrator that is on a side of the phase lead that is opposite the air gap.

3. The motor assembly of claim 2, wherein the maximum width dimension is disposed in a plane that includes a longitudinal centerline of the phase lead and a center line of the air gap.

4. The motor assembly of claim 1, wherein the maximum width dimension is greater than or equal to 150% of the minimum width dimension.

5. The motor assembly of claim 4, wherein the maximum width dimension is greater than or equal to 185% of the minimum width dimension.

6. The motor assembly of claim 1, wherein a ratio of the width of the air gap to a width of the end faces is greater than or equal to 1.5.

7. The motor assembly of claim 6, wherein the ratio is greater than or equal to 2.0.

8. The motor assembly of claim 7, wherein the ratio is equal to 2.3.

9. The motor assembly of claim 1, wherein the concentrator is formed of a plurality of plate-like lamination members.

10. The motor assembly of claim 1, wherein the Hall-effect sensor has a sensor axis that is disposed in a plane that includes a longitudinal axis of the phase lead, and a distance between the phase lead and the sensor axis is less than or equal to three-quarters of the width of the air gap.

11. The motor assembly of claim 10, wherein the distance between the phase lead and the sensor axis is equal to one-half of the width of the air gap.

12. The motor assembly of claim 1, wherein a ratio of:
a) a spacing distance (D3) between the phase lead and a plane that intersects ends of the end faces that are closest to the phase lead;
to
b) the width of the air gap is 0.18.

13. A motor assembly comprising:
a stator having a stator core and a set of field windings that are wound about the stator core, the set of field windings having a phase lead;
an inverter having a conductor electrically and mechanically coupled to the phase lead;
a concentrator disposed about the phase lead, the concentrator being generally C-shaped and having a pair of end faces that are spaced apart to define an air gap therebetween; and
a Hall-effect sensor received in the air gap between the end faces;
wherein a width of the air gap is greater than a diameter of the phase lead; and
wherein a ratio of the width of the air gap to a width of the end faces is greater than or equal to 1.5.

14. The motor assembly of claim 13, wherein the ratio is greater than or equal to 2.0.

15. The motor assembly of claim 14, wherein the ratio is equal to 2.3.

16. The motor assembly of claim 13, wherein the concentrator is formed of a plurality of plate-like lamination members.

17. The motor assembly of claim 13, wherein the Hall-effect sensor has a sensor axis that is disposed in a plane that includes a longitudinal axis of the phase lead, and a distance between the phase lead and the sensor axis is less than or equal to three-quarters of the width of the air gap.

18. The motor assembly of claim 17, wherein the distance between the phase lead and the sensor axis is equal to one-half of the width of the air gap.

19. The motor assembly of claim 13, wherein a ratio of:
a) a spacing distance (D3) between the phase lead and a plane that intersects ends of the end faces that are closest to the phase lead;
to
b) the width of the air gap is 0.18.

20. A motor assembly comprising:
a stator having a stator core and a set of field windings that are wound about the stator core, the set of field windings having a phase lead;
an inverter having a conductor electrically and mechanically coupled to the phase lead;
a concentrator disposed about the phase lead, the concentrator being generally C-shaped and having a pair of end faces that are spaced apart to define an air gap therebetween; and
a Hall-effect sensor received in the air gap between the end faces;
wherein a width of the air gap is greater than a diameter of the phase lead; and
wherein a ratio of:
a) a spacing distance (D3) between the phase lead and a plane that intersects ends of the end faces that are closest to the phase lead;
to
b) the width of the air gap is 0.18.
